(19) United States
(12) Patent Application Publication
(10) Pub. No.: US 2025/0022408 A1
(43) Pub. Date: Jan. 16, 2025

(54) LED DISPLAY SYSTEM

(71) Applicants: Paul Dorland, St. Catharines (CA); Larry Vann, St. Catharines (CA)

(72) Inventors: Paul Dorland, St. Catharines (CA); Larry Vann, St. Catharines (CA)

(21) Appl. No.: 18/899,281

(22) Filed: Sep. 27, 2024

Related U.S. Application Data
(63) Continuation of application No. 18/277,887, filed on Aug. 18, 2023, now abandoned.
(60) Provisional application No. 63/150,714, filed on Feb. 18, 2021.

(51) Int. Cl. G09G 3/32; A63B 63/00; G09G 3/00; H04N 7/015

(52) U.S. Cl. CPC G09G 3/32; G09G 3/035; A63B 63/004; A63B 2225/74; A63B 2243/0025; H04N 7/015

(57) ABSTRACT

A light emitting diode (LED) display system includes: a net; a plurality of LED strings supported by the net, each LED string comprising a plurality of connected LED pods each comprising an LED; and control structure in communication with the LED strings. The control structure outputs a plurality of control signals to the LED strings for providing an illuminated display.

### CROSS-REFERENCE TO RELATED APPLICATION

This application is a continuation of U.S. patent application Ser. No. 18/277,887, which is a 371 national stage entry of PCT Application No. PCT/CA2022/050201 filed Feb. 11, 2022, which claims the benefit of U.S. Provisional Application No. 63/150,714 filed on Feb. 18, 2021, the content of which is incorporated herein by reference in its entirety.

### FIELD

The subject disclosure relates generally to lighting systems and in particular, to an LED display system.

### BACKGROUND

In the field of athletics infrastructure, netting is used for a variety of purposes, such as for providing a barrier for player and spectator safety, for demarcating court or game boundaries, and/or for trapping a ball or game projectile in a goal.

In other fields, such as building construction, netting is used for providing a barrier for public safety, for demarcating areas of construction, and/or for traffic management. In some cases, it is desirable for building construction netting to include features such as signs, plaques or active display elements to convey signals or other information to the public. Such active display elements can be illuminating elements, such as fiber optic strands, to enable the signals to be visible at night.

Building construction netting incorporating illuminating elements has been described. For example, U.S. Pat. No. 6,969,185 discloses a safety net that includes at least one illuminating element. The safety net is intended to be stored in a rolled-up fashion similar to a roll-up window shade in the trunk of a vehicle. When illuminated, the safety net provides a completely new and unique means of alerting oncoming traffic to a road hazard or other situation requiring traffic control. The safety net provides a warning means that will not be knocked over by the wind, as wind blows freely through the voids of the net. In addition, the safety net screens the scene from the view of those in oncoming traffic. The device may include a solid state controller that provides a variety of patterns or symbols to further enhance the visual safety features of the device. This can be accomplished by placing fiber optic strands in the net voids, or within the side illuminating fiber optic conduit itself. The device may also include metal cables to form a physical barrier.

Sports netting incorporating illuminating elements has also been described. For example, German Patent Document No. DE102009056915 describes a net that has a net body formed from lattice-shaped net threads that are connected with each other. The net body includes meshes with predetermined mesh width that allows unrestricted view through the net body. The net body includes lighting units, such as LEDs, elastic covers and lighting fibers, which are connected with entire or parts of the net threads. The lighting units are directly switched by an electronic, photo or switching technical or radar technical sensing device.

International PCT Application No. WO 2019014739 relates to conveying light-based media from a sports net. A sports net formed by nylon or similar strips positioned both vertically and horizontally, incorporates an electronic mesh provided with LEDs. The net is kept protected by flaps with Velcro closure, forming a single sports net, such that the LEDs thereof are exposed inside the goal structure, generating images back to the TV camera, and thus, upon impacts by the ball inside the goal structure, said sports net will catch the impact without damage to the wires and the LEDs in addition to simultaneously conveying the aforesaid images.

Chinese Utility Model Document No. 203338679 to Jude Shenzhen Science and Technology Co. Ltd. describes a light source unit for a reticulate display screen. The light source unit comprises a base, a lamp panel and a lampshade, wherein the base is provided with a wire duct through which grid lines penetrate, the lamp panel is arranged on the base, and the lampshade is arranged on the base in a covering mode and covers the lamp panel. The lampshade is detachably connected with the base. The utility model further discloses the reticulate display screen using the light source unit. According to the reticulate display screen and the light source unit of the reticulate display screen, when the reticulate display screen is broken down, the lampshade is assembled, the lamp panel is replaced, maintenance to the whole light source unit is achieved, therefore, the whole maintaining process is simple and maintaining efficiency is high.

Chinese Utility Model Document No. 203338682 to Jude Shenzhen Science and Technology Co. Ltd. describes a display screen module which comprises a flexible base and a display module, wherein the flexible base is used for being attached to a display surface, and the display module comprises a plurality of point light-emitting units. The point light-emitting units are dispersedly fixed to the flexible base. Due to the ability of the flexible base which to be bent and deformed along with the display surface is arranged, and the point light-emitting units being dispersedly fixed to the flexible base, the whole display screen module can be attached to the special-shaped surface to conduct display, and the requirements for display on various special-shaped surfaces including curved surfaces are met.

Improvements are generally desired. It is object at least to provide a novel LED display system.

### SUMMARY

In one aspect, there is provided a light emitting diode (LED) display system, comprising: a net; a plurality of LED strings supported by the net, each LED string comprising a plurality of connected LED pods each comprising an LED; and control structure in communication with the LED strings, the control structure outputting a plurality of control signals to the LED strings for providing an illuminated display.

The control structure may comprise: a video source; a controller configured to receive a video signal from the video source and to generate a processed video signal; and a driver box configured to receive the processed video signal from the controller and to output a respective binary output signal to each of the LED strings.

The controller and the video source may be in communication via a high-definition multimedia interface (HDMI) cable. The controller and the driver box may be in communication via a category 5 (Cat 5) cable. Communication between the controller and at least one of the video source and the driver box, may be wireless.

Each LED pod may be configured to be individually addressable. Each LED pod may further comprise a plurality of LEDs. Each LED may be configured to be individually addressable. Each LED may be a red-green-blue (RGB) LED.

Each LED string may further comprise a plurality of LED cable segments connecting the LED pods. The LED pods may be removably connected to the LED cable segments.

Each LED pod may be removably connected to the net. Each LED pod may comprise a housing accommodating the LED.

The housing may be configured to prevent moisture ingress. The housing may be configured to direct light emitted by the LED in a generally forward direction. The housing may be configured to direct light emitted by the at least one LED over an angular range of less than 175 degrees.

The housing may comprise connecting structure for removably connecting the LED pod to the net. The connecting structure may comprise at least a portion of hook-and-loop material. The connecting structure may comprise a fastener secured to the net, the fastener being configured to receive the LED pod. The fastener may be configured to receive the LED pod by snapping the LED pod into the fastener. The connecting structure may comprise an eyelet or an aperture sized to receive a portion of the net therethrough. The portion of the net may be a tether cable.

A portion of each LED string may be co-woven with the net.

### BRIEF DESCRIPTION OF DRAWINGS

Embodiments will now be described more fully with reference to the accompanying drawings in which:

FIG. 1 is a perspective view of an LED display system, comprising an illuminated netting;

FIG. 2 is an enlarged fragmentary view of a portion of the illuminated netting of FIG. 1;

FIG. 3 is an exploded view of the illuminated netting of FIG. 2;

FIG. 4 is a schematic block diagram of a portion of an LED pod forming part of the illuminated netting of FIG. 1; and

FIG. 5 is an enlarged fragmentary view of another embodiment of an illuminated netting.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art.

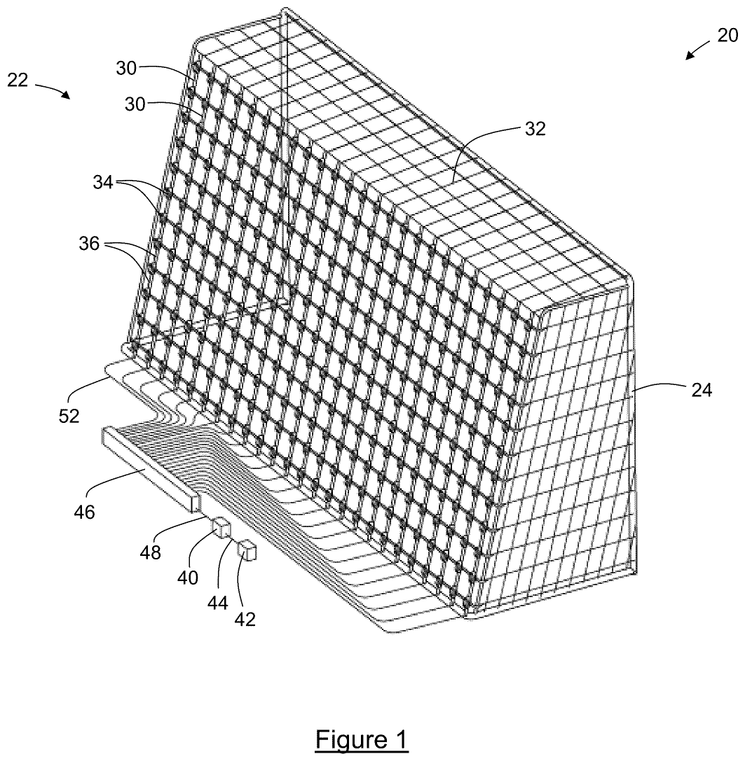

Turning now to FIG. 1, an LED display system is shown and is generally identified by reference numeral 20. LED display system 20 comprises an Illuminated netting 22 comprising a plurality of LEDs. The Illuminated netting 22 is configured to provide a generally two-dimensional (2D) illuminated display visible to persons in its vicinity, and to serve as a physical barrier. In the embodiment shown, the LED display system 20 is installed at a soccer field, and the Illuminated netting 22 is secured to a soccer goal frame 24 and thereby forms part of a soccer goal. However in other embodiments, the LED display system 20 may be installed at another location, and the Illuminated netting 22 may form part of another structure.

The illuminated netting 22 comprises a plurality of LED strings 30 coupled to a net 32. Each LED string 30 comprise a plurality of LED pods 34 that are electrically connected by LED cable segments 36, with each LED pod 34 accommodating at least one LED. In the example shown, the Illuminated netting 22 comprises twenty-five (25) strings 30, with each string 30 being oriented in a generally vertical direction and comprising twelve (12) LED pods 34, and with each LED pod 34 comprising two (2) LEDs. As will be understood, in the example shown, the illuminated netting 22 provides a generally 2D illuminated display comprising twenty-five by twelve (25×12) pixels, with each LED pod 34 serving as an individually addressable single pixel of the 2D illuminated display.

As will be understood, the net 32 supports the LED strings 30, and is configured to serve as a barrier in the manner of a conventional net. The net 32 is fabricated of a netting material having suitable strength and durability. In this embodiment the net 32 is fabricated of lengths of woven nylon strap, however in other embodiments the net 32 may alternatively be fabricated of other suitable materials.

LED display system 20 further comprises control structure for controlling the LEDs of the Illuminated netting 22. In this embodiment, the LED display system 20 comprises a controller 40 that is in communication with a video source 42 via a video cable 44, and a driver box 46 that is in communication with the controller 40 via a driver cable 48. The controller 40 is configured to receive a video signal output by the video source 42 via the cable 44. The controller 40 is configured to convert the video signal into a processed video signal having a format that can be read and processed by the driver box 46, and to output the processed video signal to the driver box 46 via the driver cable 48. The driver box 46, in turn, is configured to convert the processed video signal into a plurality of binary output signals, and to output a respective binary output signal to each LED string 30 via a respective output cable 52. The control structure also comprises a power source (not shown) for powering the LED strings 30, the controller 40, and the driver box 46. In the example shown, the video cable 44 is a high-definition multimedia interface (HDMI) cable, the video signal output by the video source 42 is an HDMI signal, and the driver cable 48 is a Category 5 (Cat 5) cable. The controller 40 may be, for example, a MCTRL700 LED Screen Video LED Control Box manufactured by Novastar Technology of Las Vegas, U.S.A.

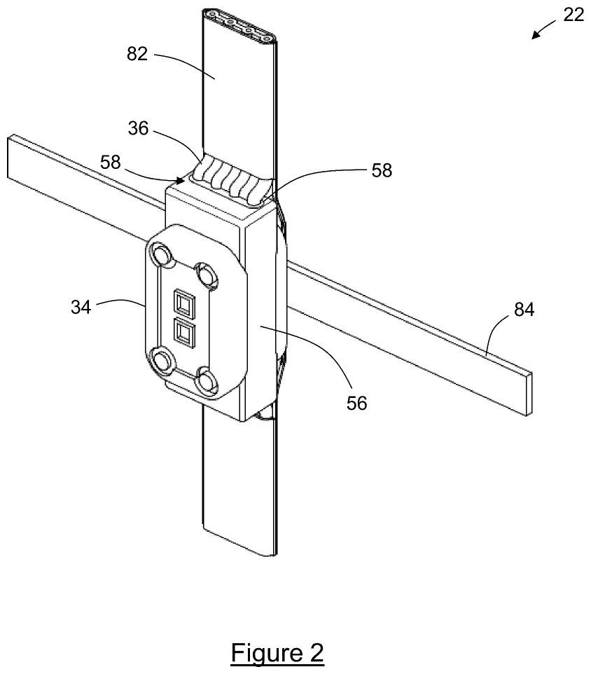

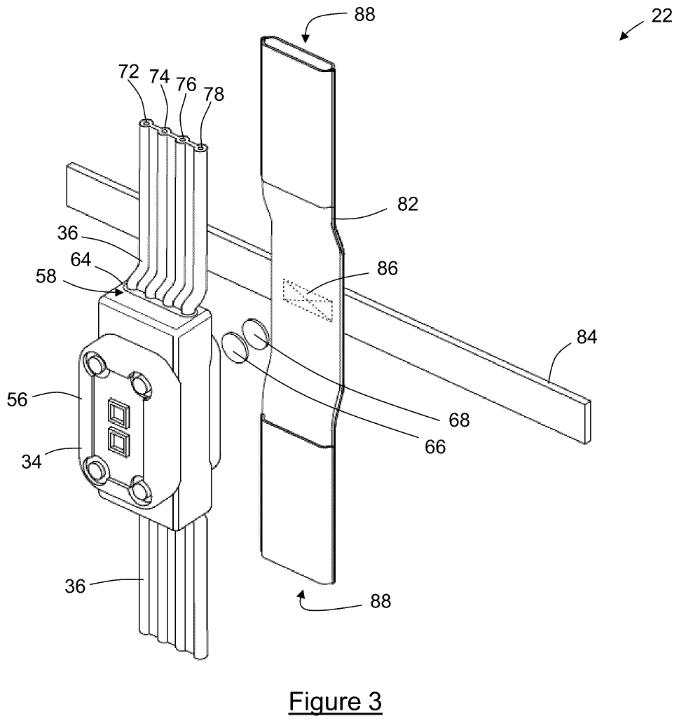

The illuminated netting 22 may be better seen in FIGS. 2 and 3. Each LED pod 34 comprises a rigid, elongate housing 56 that encloses the LEDs and their accompanying circuitry. The housing 56 is fabricated of a waterproof material having suitable durability, and is configured to withstand direct impact from sports objects travelling at high speed, such as hockey pucks, baseballs, and the like, and to prevent the ingress of moisture. In this embodiment, the housing 56 is fabricated of plastic. Connector ports 58 and 62 are provided at each opposing end of the housing 56 for providing a detachable connection to connector 64 of a LED cable segment 36. The housing 56 has a first fastener portion 66 secured to a rear side thereof, and which is configured to detachably fasten to a second fastener portion 68 secured to the net 32. In the example shown, the first fastener portion 66 and the second fastener portion 68 are complimentary portions of hook-and-loop material, however it will be appreciated that other types of fastener, such as hooks, clips, straps, bands, and the like, may alternatively be used. As will be understood, by providing detachable connections between the LED pods 34 and the LED cable segments 36, and between the LED pods 34 and the net 32, faulty or damaged LED pods 34 can be easily removed and replaced with functioning LED pods 34, without having to dismantle the entire Illuminated netting 22.

The LED pod 34 is configured, through the positions of the LEDs within the LED pod 34 and the fastening of the LED pod 34 to the net 32, to direct emitted light in a desired forward direction, and not in a backwards direction. In this embodiment, light is emitted from the LED pod 34 within an angular range of approximately 160° about the normal direction N to the front surface of the housing 56.

The LED cable segments 36 comprise insulated wiring for providing data signals, power and ground to the LED pods 34 of each string 30. In the example shown, the LED cable segments 36 comprise four (4) insulated wires, namely a power wire 72, a data wire 74, a failed data wire 76, and a ground wire 78, and the LED cable segment 36 has a generally flat or “ribbon”-shaped profile. A respective connector 64 is provided at each end of the LED cable segment 36, for enabling the end of the LED cable segment 36 to be electrically connected to an LED pod 34.

The net 32 comprises a plurality of first strands 82 oriented in a direction parallel to the LED strings 30, and a plurality of second strands 84 oriented in a non-parallel direction to the LED strings 30. The first and second strands 82 and 84 are fastened together at intersections of the first and second strands 82 and 84. In the example shown, first and second strands 82 and 84 are fastened by stitching 86 at the intersections.

The first strands 82 comprise loops 88 spaced along the length of the first strands 82, and which are each sized to accommodate a portion of the length of a LED cable segment 36. In the example shown, the loops 88 are integrally formed with each first strand 82.

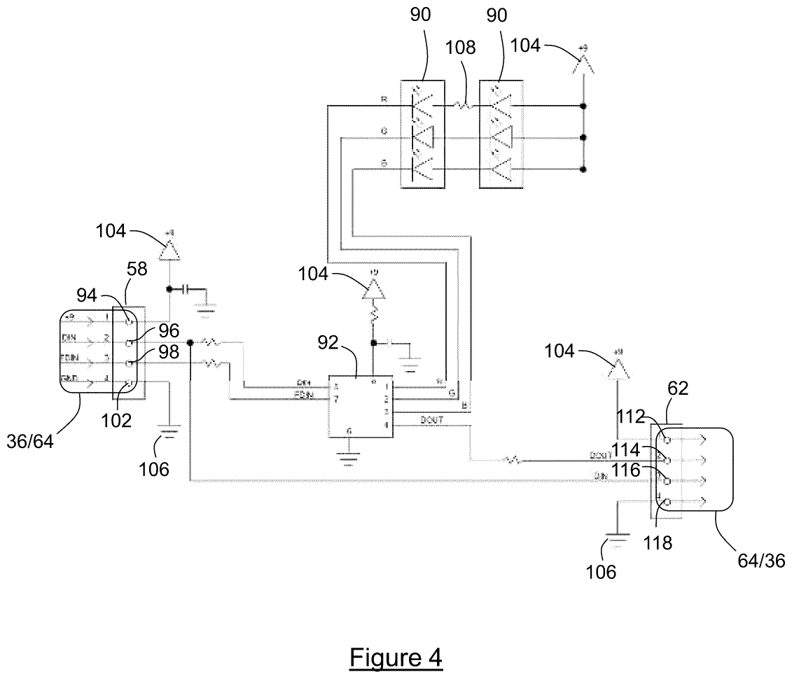

The LED pod 34 may be better seen in FIG. 4. The LED pod 34 comprises two (2) LEDs 90, a controller chip 92 in communication with the LEDs 90, an input connector port 58 in communication with the with the controller chip 92, and an output connector port 62 in communication with the with the controller chip 92. Each LED 90 is a red-green-blue (RGB) LED, and comprises a red diode, a green diode, and a blue diode. The controller chip 92 comprises a plurality of pins for connecting to components of the LED pod 34 and in the example shown, the controller chip 92 is an eight (8)-pin microcircuit controller. The controller chip 92 may be, for example, a UCS5603 microcircuit controller.

The input connector port 58 comprises a first pin 94, a second pin 96, a third pin 98 and a fourth pin 102. When the input connector port 58 and the connector 64 of the cable segment 36 are connected, the first pin 94 is configured to receive power from power wire 72, the second pin 96 is configured to receive a binary output signal from data wire 74, the third pin 98 is configured to receive a backup (or “failed”) binary output signal from the failed data wire 76, and the fourth pin 102 is configured to provide a ground connection with ground wire 78.

The first pin 94 is connected to a power bus 104, which provides power throughout the LED pod 34. In the example shown, the power supplied is +9V. The second pin 96 and the third pin 98 are each in communication with respective pins of the controller chip 92. The fourth pin is connected to a ground bus 106, which provides a ground line throughout the LED pod 34.

The controller chip 92 is connected, via respective pins thereof, to the power bus 104 and the ground bus 106. The controller chip 92 is configured to process the binary output signal received via second pin 96, and generate a red output signal, a green output signal, and a blue output signal. The red, green and blue output signals are each pulse width modulated (PWM). PWM is a commonly known method used to control the brightness of an LED by adjusting the average power delivered by an electrical signal. As will be understood, the power supplied is switched on and off at a fast rate, creating a discrete signal, whereby the longer the period of time that power is supplied, compared to the period of time that power is not supplied, the higher the power supplied, and the brighter the LED output. The controller chip 92 outputs each of the three (3) output signals via a respective pin to the red diodes, the green diodes and the blue diodes of the LEDs 90. If the controller chip 92 does not receive a binary output signal via second pin 96, the controller chip 92 is configured to process a backup (or “failed”) binary output signal received via third pin 98, make optional pixel positioning adjustments, and generate the red output signal, the green output signal, and the blue output signal.

The controller chip 92 is also configured to generate and output a respective binary output signal, which is in the form of a display data cascade out signal, and to output this signal to the output connector port 62. The controller chip 92 is further configured to generate and output the failed binary output signal, and to output this signal to the output connector port 62.

The LEDs 90 are connected, in series, to the power bus 104. A resistor 108 attenuates the red output signal between the red diodes of the LEDs 90.

The output connector port 62 comprises a first pin 112, a second pin 114, a third pin 116 and a fourth pin 118. The first pin 112 is connected to the power bus 104, and the fourth pin 118 is connected to the ground bus 106. The second pin 114 is connected to the controller chip 92 and is configured to receive the binary output signal therefrom. The third pin 116 is connected, indirectly, to the second pin 96 of the input connector port 58 and is configured to receive the binary output signal output by the controller chip of the previous LED pod 34 in the LED string 30 (or, if the LED pod 34 is the first in the LED string 30, from the driver box 46). As will be understood, in the event of failure of the controller chip 92, the LEDs 90, and/or other components of the LED pod 34, binary output signal received at second pin 96 is communicated to the next LED pod 34 in the string 30, allowing the signal to effectively bypass or “hop over” the failed LED pod 34 and thereby enabling successive LED pods 34 to function correctly.

When the output connector port 62 and the connector 64 of a subsequent cable segment 36 are connected, the first pin 112 is configured to provide power to the power wire 72, the second pin 114 is configured to provide the binary output signal to the data wire 74, the third pin 116 is configured to provide the failed binary output signal to the failed data wire 76, and the fourth pin 102 is configured to provide a ground connection with ground wire 78.

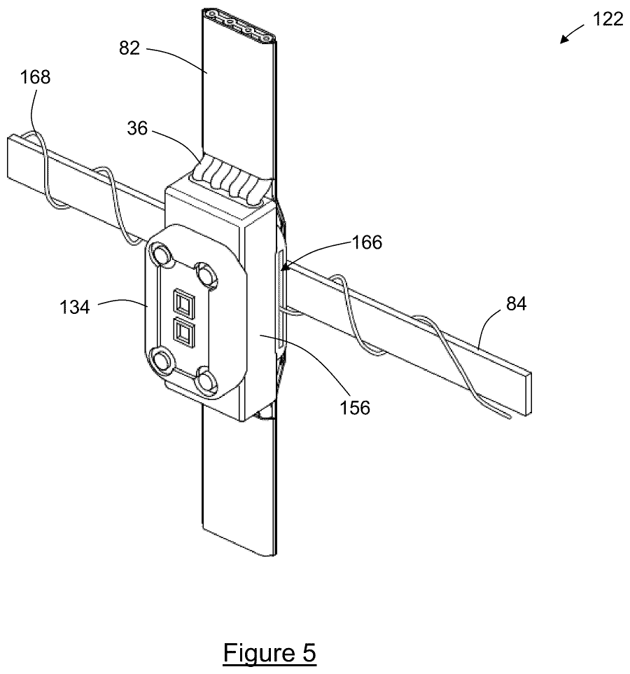

In other embodiments, the LED system and its components may be differently configured. For example, FIG. 5 shows another embodiment of an illuminated netting for use with the LED display system 20, and which is generally indicated by reference numeral 122. Illuminated netting 122 is generally similar to illuminated netting 22 described above and with reference to FIGS. 1 to 4, and comprises a plurality of LED strings coupled to the net 32. Each LED string comprises a plurality of LED pods 134 that are electrically connected by the LED cable segments 36, with each LED pod 134 accommodating at least one LED.

Each LED pod 134 comprises a rigid, elongate housing 156 that encloses the LEDs and their accompanying circuitry. Connector ports are provided at each opposing end of the housing 156 for providing a detachable connection to the connector 64 of a LED cable segment 36. In this embodiment, the housing 156 has an eyelet 166 formed in a rear side thereof. The eyelet 166 is sized to accommodate a tether cable 168 secured to the second strand 84 of the net 32, for fastening the LED pod 134 to the net 32. As will be understood, the tether cable 168 can be cut and tied, as needed, in the event a LED pod 134 is faulty or damaged and needs to be removed and replaced.

Still other configurations are possible. For example, although in the embodiment described above, the LED pod 34 comprises two (2) LEDs 90, with each LED 90 being a red-green-blue (RGB) LED, in other embodiments, the LED pod may alternatively comprise only one (1) LED or may alternatively comprise more than two (2) LEDs, with each being a red-green-blue (RGB) LED.

Although in the embodiments described above, each LED pod 34 serves as an individually addressable single pixel, and thereby the LEDs 90 of the LED pod 34 form an individually addressable pair, in other embodiments, each LED of the LED pod may alternatively be individually addressable, such that each individual LED of each LED pod is individually addressable.

Although in the embodiments described above, the LED cable segment 36 has a generally flat or “ribbon”-shaped profile, in other embodiments, the LED cable segment may alternatively have a braided profile. As will be understood, as the width of a LED cable segment having a braided profile is less than that of the “ribbon”-shaped profile, an illuminated netting comprising LED cable segments would provide less obstructive sight lines to spectators.

Although in the embodiments described above, the controller 40 is in communication with the video source 42 via a video cable 44, in other embodiments, each of the controller 40 and the video source 42 may alternatively be configured such that they are in communication with each other via a wireless connection, whereby the controller 40 is configured to receive the video signal output by the video source 42 wirelessly using a suitable wireless protocol such as for example Bluetooth™, Wi-Fi™, ZigBee™, ANT™, IEEE 802.15.4, Z-Wave™, Ethernet, and the like.

Although in the embodiments described above, the driver box 46 is in communication with the controller 40 via the driver cable 48, in other embodiments, each of the controller 40 and the driver box 46 may alternatively be configured such that they are in communication with each other via a wireless connection, whereby the controller 40 is configured to output the processed video signal to the driver box 46 wirelessly using a suitable wireless protocol such as for example Bluetooth™, Wi-Fi™, ZigBee™, ANT™, IEEE 802.15.4, Z-Wave™, Ethernet, and the like.

Although in the embodiments described above, the housing 56 of the LED pod 34 has the first fastener portion 66 secured to a rear side thereof, and which is configured to detachably fasten to the second fastener portion 68 secured to the net 32, in other embodiments, the LED pods 34 may alternatively be configured to removably connect to the net 32 by “snapping into” and “snapping out” of a fastener (not shown) secured to the net 32 that is designed to receive the housing of an LED pod.

In other embodiments, at least a portion of the LED cable segments may be woven into, or other incorporated into, the net 32.

Although embodiments have been described above with reference to the accompanying drawings, those of skill in the art will appreciate that variations and modifications may be made without departing from the scope thereof as defined by the appended claims.

What is claimed is:

1. A light emitting diode (LED) display system, comprising:
a net;
a plurality of LED strings supported by the net, each LED string comprising a plurality of connected LED pods each comprising an LED; and
control structure in communication with the LED strings, the control structure outputting a plurality of control signals to the LED strings for providing an illuminated display.

2. The system of claim 1, wherein the control structure comprises:
a video source;
a controller configured to receive a video signal from the video source and to generate a processed video signal; and
a driver box configured to receive the processed video signal from the controller and to output a respective binary output signal to each of the LED strings.

3. The system of claim 2, wherein the controller and the video source are in communication via a high-definition multimedia interface (HDMI) cable.

4. The system of claim 2, wherein the controller and the driver box are in communication via a category 5 (Cat 5) cable.

5. The system of claim 2, wherein communication between the controller and at least one of the video source and the driver box, is wireless.

6. The system of claim 1, wherein each LED pod is configured to be individually addressable.

7. The system of claim 6, wherein each LED pod further comprises a plurality of LEDs.

8. The system of claim 6, wherein each LED is configured to be individually addressable.

9. The system of claim 6, wherein each LED is a red-green-blue (RGB) LED.

10. The system of claim 1 wherein each LED string further comprises a plurality of LED cable segments connecting the LED pods.

11. The system of claim 10, wherein the LED pods are removably connected to the LED cable segments.

12. The system of claim 1 wherein each LED pod is removably connected to the net.

13. The system of claim 12, wherein each LED pod comprises a housing accommodating the LED.

14. The system of claim 13, wherein the housing is configured to direct light emitted by the LED in a generally forward direction.

15. The system of claim 14, wherein the housing is configured to direct light emitted by the at least one LED over an angular range of less than 175 degrees.

16. The system of claim 13, wherein the housing comprises connecting structure for removably connecting the LED pod to the net.

17. The system of claim 16, wherein the connecting structure comprises one of:
at least a portion of hook-and-loop material;
a fastener secured to the net, the fastener configured to receive the LED pod, wherein the fastener is configured to receive the LED pod by snapping the LED pod into the fastener; and
an eyelet or an aperture sized to receive a portion of the net therethrough.

18. The system of claim 17, wherein the portion of the net is a tether cable.

19. The system of claim 1, wherein a portion of each LED string is co-woven with the net.
